(19) United States
(12) Patent Application Publication
(10) Pub. No.: US 2025/0161009 A1
(43) Pub. Date: May 22, 2025

(54) MAGNETICALLY RETAINED DENTAL PROSTHESIS

(71) Applicant: Metro North Hospital and Health Services, Herston (AU)

(72) Inventors: Martin BATSTONE, Sydney (AU); James NOVAK, Sydney (AU); Danilo CARLUCCIO, Sydney (AU); Stefan DI MEDIO, Sydney (AU); George DIMITROULIS, Sydney (AU)

(73) Assignee: Metro North Hospital and Health Services, Herston (AU)

(21) Appl. No.: 18/729,617

(22) PCT Filed: Feb. 15, 2023
(86) PCT No.: PCT/AU2023/050101

§ 371 Date: Jul. 17, 2024

(30) Foreign Application Priority Data
Feb. 18, 2022 (AU) 2022900367

(51) Int. Cl. A61C 13/235; A61C 8/00; A61C 13/02

(52) U.S. Cl. CPC A61C 13/235; A61C 8/0031; A61C 8/0081; A61C 8/0095; A61C 13/02

(57) ABSTRACT

The present dental prosthesis has a palatal implant configured to be implanted subperiosteally and attached to the palatal process by a plurality of fixation screws. The implant has a spine retaining implant magnetic components therealong and having holes for the fixation screws. The prosthesis also has a maxilla denture having a palatal base plate and an alveolar ridge engaging periphery having false teeth installed thereon. The denture is configured to be placed in a mouth to engage a maxilla wherein the alveolar ridge engaging periphery engages an alveolar ridge of the maxilla. The denture comprises a plurality of denture magnetic components configured to align with the implant magnetic components so that the denture is magnetically retained in the mouth by magnetic attraction force between the implant magnetic components and the denture magnetic components.

### FIELD OF THE INVENTION

This invention relates generally to a type of magnetically retained dental prosthesis.

### BACKGROUND OF THE INVENTION

Millions of people around the world are edentulous and rely on dentures or prosthetic teeth for appearance, chewing and speech. Those who have been edentulous for more than 10 years suffer from unstable fitting dentures because of progressive loss of jawbone through the natural process of bone resorption. This cohort of denture wearing people rely to a large extent on denture adhesives that come in various forms that help stick the denture to the gum and palate which is essentially gluing false teeth to gums to prevent them from falling out.

Denture adhesives are cumbersome and costly over time as the adhesive is applied daily. The old adhesive is hard to clean off the fitting surface of the denture when the stickiness gradually subsides before the new adhesive can be applied. Many people, particularly in nursing homes, are unable to wear their false teeth because of the instability and the difficulty in applying denture adhesives on a daily basis.

Denture adhesives are currently the simplest and cheapest solution for improving denture stability in patients with receded gums. Alternative solutions are available in the form of dental implants which provide excellent stability, but the cost can be prohibitive for most people. Furthermore, for dental implants to work, there must be enough bone to accommodate the dental implant fixtures which are drilled into the jawbone. For patients with loose maxillary dentures, often there isn't enough bone for dental implants which necessitates additional complex reconstructive surgery involving bone grafts, osteotomies and expensive membranes which often requires many months of healing before implants and teeth can be finally fitted.

Attempts to retain dental prosthesis despite bone resorption include CN 102058440 A (DALIAN SUNNY TITANIUM INDUSTRY CO LTD) 18 May 2011 which discloses a micro titanium plate magnetic attachment which has a planar titanium plate designed to be attached to the alveolar bones despite severe bone resorption.

Other forms of magnetically retained dentures include U.S. Pat. No. 4,202,097 A (ERLICH-DEGUEMP) 13 May 1980 which discloses magnetic securement of dental prosthesis in position by a magnetic device which is attached to a seating or foundation structure which is permanently fixed, preferably by keying, in a cavity in the bone. The magnetic element may be releasable from the seating or foundation structure. In the case of a complete palatal base-plate, the prosthesis will be maintained by at least two magnetic devices situated on both sides of the alveolar ridge of the jaw.

WO 2014013114 A1 (SALGADO MARTIN) 23 Jan. 2014 also discloses an implant that is especially designed to be attached to the alveolar ridge of the maxilla to secure a dental prosthesis.

The present invention seeks to provide a way to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein an alternative simple and cost-effective magnetically supported denture which can reduce or eliminate the need for denture adhesives wherein magnetic attraction between a magnetic palatal implant implanted under the oral mucosa and magnetic components within the denture provide sufficient attractive forces to keep the denture firmly in place but can easily be removed for cleaning.

More specifically, the dental prosthesis comprises a palatal implant configured to be implanted subperiosteally under the under the oral mucosa and attached to the palatal process by a plurality of fixation screws.

The palatal implant has a spine retaining implant magnetic components therealong and having holes for the fixation screws.

The prosthesis further comprises a maxilla denture having a palatal base plate and an alveolar ridge engaging periphery having false teeth installed thereon.

The denture is configured to be placed in a mouth to engage a maxilla wherein the alveolar ridge engaging periphery engages an alveolar ridge of the maxilla.

The denture comprises a plurality of denture magnetic components configured to align with the implant magnetic components so that the denture is magnetically retained in the mouth by magnetic attraction force between the implant magnetic components and the denture magnetic components.

Whereas the palatal process is relatively thin and frail as compared to the bone of the alveolar ridge, the elongate nature of the palatal implant and the plurality of fixation screws therealong allow adequate securement to the this palatal process using a plurality of spread apart microscrews.

Furthermore, the present prosthesis allows implantation of the palatal implant away from the alveolar process, thereby avoiding attachment complications caused by bone resorption.

Furthermore, the present prosthesis allows the significant biting force applied by the false teeth to be borne by the alveolar ridge engaging periphery without application of significant force to the palatal implant. In embodiments, the prosthesis may allow a small gap between the palatal baseplate of the maxilla denture and the oral mucosa over the palatal process thereby allowing magnetic attraction whilst avoiding abrasion or bruising of the oral mucosa.

The palatal implant is preferably relatively low profile and defining planar upper and lower surfaces to thereby suit being installed flat under the oral mucosa. In this regard, the implant is preferably less than 4 mm thick and is approximately 1 mm thick in embodiments.

The spine of the palatal implant may allow bending thereof to geometrically conform to the patient specific anatomy of the palatal process.

The spine may have open housings into which magnetic inserts are pressed. Furthermore, any magnetic or ferromagnetic material of the magnetic inserts may be hermetically sealed within the housing, and/or have a biocompatible and durable coating prior to being pressed into the housing.

In embodiments, the implant may provide in-line fixation screw holes along the length of the spine and/or lateral fixation screw holes laterally adjacent the spine. As such, the implant may be resiliently attached in alignment with the spine along the length thereof and/or laterally braced. Furthermore, the lateral fixation screw holes may spread the fixation screws apart to avoid likelihood of fracture of the relatively thin palatal process. Furthermore, the in-line and lateral fixation holes allow for choice of fixation screw placement.

In embodiments each magnetic component may be adequately surrounded by a quadrant of fixation holes to withstand magnetic force applied thereto.

The palatal implant is surgically implanted onto maxillary bone via palatal mucoperiosteal flaps (or similar procedures, including via buccal, labial mucoperiosteal flaps) which are lifted to expose the underlying jawbone.

The implant may be placed directly onto the maxillary bone along the palate and secured with pins, glue, clips, screws or the like.

The overlying mucoperiosteal flaps (gum/mucosa) is then positioned back into place to completely cover the implant. After a short healing period, the patient's existing or new maxillary dentures are fitted with corresponding magnetic components (preferably of opposite polarity) into fitting surfaces of the dental prosthesis. The newly processed denture with embedded magnets is then fitted onto the edentulous maxilla and retained via the subperiosteally implanted magnetic components of the implant. Preferably, the magnets of the implant and denture are of opposite polarity to provide sufficient force of attraction required to keep the denture firmly in place during function such as smiling, talking, and chewing. The magnetic components may comprise strong rare earth magnets including neodymium.

The present prosthesis involves simple surgery and simple modification of existing dentures and avoids having to rely on daily rituals of applying denture adhesives.

Whereas denture adhesive strength may decline over the course of a day requiring tedious removal and reapplication practices, the magnetic force of the present dental prosthesis remains constant and does not fade as the day progresses, enhancing denture retention.

Furthermore, the present magnetically retained dental prosthesis negates the need for expensive and protracted course of treatment involved in fixed implant solutions.

Furthermore, the covering of the implant by the mucosa avoids use of transmucosal components that are inherent to conventional fixed implant solutions and associated problems of soft tissue complications including infections and wound breakdown. Essentially, the lack of transmucosal components protruding through the gingiva and oral mucosa reduces the chance of oral bacteria infiltrating through the mucosal barrier and onto the embedded implant. The magnetic technique is also self-positioning and aids in correct denture placement.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a palatal implant of dental prosthesis configured to be implanted subperiosteally against the palatal process;

FIG. 2 shows a side elevation view of the implant of FIG. 1;

FIG. 3 shows a top plan view of the implant of FIG. 1;

FIG. 4 shows a palatal view of the maxilla with two implants attached to the palatal bone;

FIG. 5 shows an implant of the prosthesis in accordance with a further embodiment;

FIG. 6 shows a cross-sectional view of a magnetic component of the implant in accordance with an embodiment;

FIG. 7 shows a frontal plane cross-sectional view of the dental prosthesis;

FIG. 8 shows the process of installation of the dental prosthesis;

FIG. 9 shows a cross-sectional view of a magnetic component of the implant in accordance with a further embodiment; and

FIG. 10 shows a cross-sectional view of a magnetic component of the implant in accordance with a yet further embodiment.

### DESCRIPTION OF EMBODIMENTS

FIG. 7 shows dental prosthesis 100 comprising a palatal implant 101 configured to be implanted subperiosteally under the oral mucosa 102 and attached directly to the palatal process 103 by a plurality of fixation screws 104.

The implant 101 may be generally elongate and low profile/flat. The implant 101 may comprise a spine 105 retaining implant magnetic components 106 therealong.

The implant 101 may be made of a biocompatible metal such as titanium.

The implant 101 defines a plurality of fixation screw holes. In an embodiment, the implant 101 has side wings 107A having respective fixation screw holes 123A for fixation screws 104.

The prosthesis 100 further comprises a maxilla denture 108 having a palatal baseplate 109 and an alveolar ridge engaging periphery 110 having false teeth 111 installed thereon. The denture 108 is configured to be placed in a mouth to engage a maxilla 112 wherein the alveolar ridge engaging periphery 110 thereof engages an edentulous alveolar ridge 113 of the maxilla 112.

The denture 108 comprises a plurality of denture magnetic components 114 configured to align with the implant magnetic components 101 so that the denture 108 is magnetically retained in the mouth by magnetic attraction force between the implant magnetic components 101 and the denture magnetic components 114.

The magnetic components 101, 114 are preferably permanent magnets of opposite polarity to thereby exhibit sufficient force of magnetic attraction to hold the denture 108 within the mouth.

The substantially central location of the magnetic components 101, 114 helps avoid attachment of the implant 101 to the alveolar ridge and associated problems of bone resorption thereof.

Furthermore, significant biting force applied by the false teeth 111 is borne by the alveolar ridge engaging periphery 110 without application of significant force to the fragile palatal process 103. As is evident from FIG. 7, the denture 108 may be configured to allow a small gap 115 between the palatal baseplate 109 and the oral mucosa 102 covering the palatal process 103, thereby avoiding abrasion or bruising of the oral mucosa 102.

The palatal implant is preferably relatively low profile to suit being installed flat under the oral mucosa 102. In this regard, the implant 101 is preferably less than 4 mm thick. In embodiments, the implant 101 is approximately 1 mm thick.

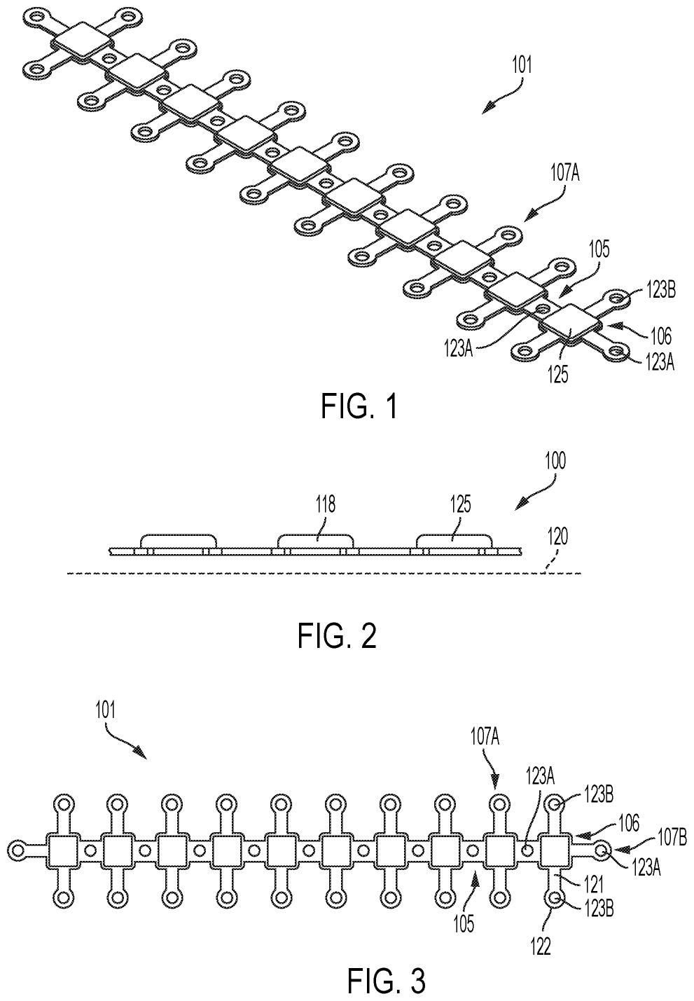

FIGS. 1-3 show an embodiment wherein a magnetic block 125 (which may comprise permanent magnet or ferromagnetic (i.e., ferrous) material) is attached to a surface of a planar spine 105.

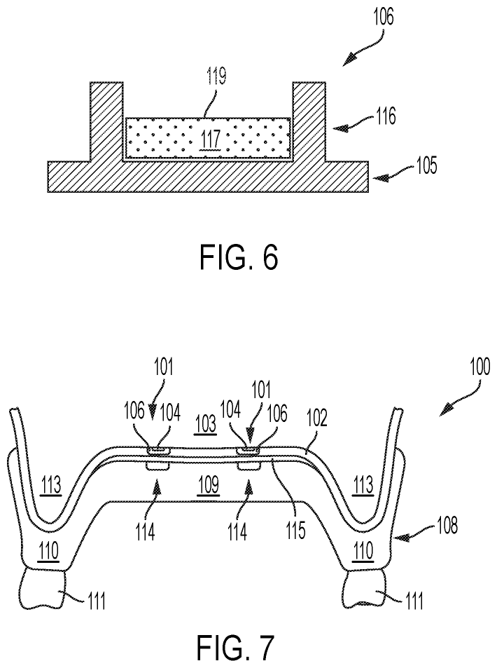

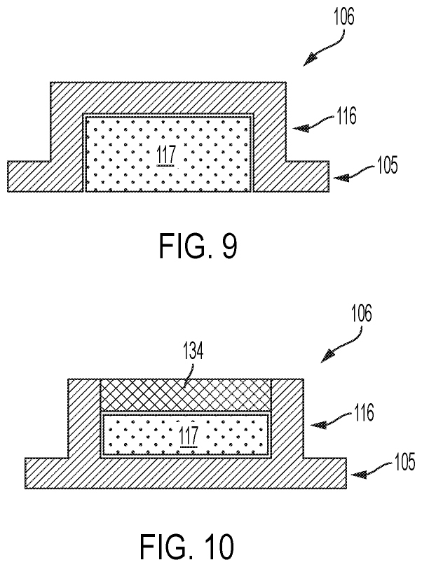

However, FIGS. 5 and 6 show an embodiment wherein the spine 105 has an open housing 116 and wherein a respective magnetic insert 117 is installed therein. The housing 116 may be integrally formed with the spine 105. For example, the implant 100 may be CNC routed so that the housing 116 and spine 105 is integrally formed.

Whereas the embodiment of FIG. 6 shows the housing 116 defining a top surface opening into which the magnetic insert 117 is inserted from the top of the magnetic component 106 (that is, opposite the underside attachment surface of the magnetic component 106 or implant 101), FIG. 9 shows an alternative embodiment wherein the magnetic component 106 defines a rear surface opening into the housing 116 (i.e., through the attachment surface of the magnetic component 106 or implant 101) into which the magnetic insert 117 is inserted into the housing 116 from the rear of the magnetic component 106. This arrangement mitigates against potential unwanted dislodgement of the magnetic insert 117 through the top of the implant 101 towards the denture 108 by magnetic attraction.

In the embodiment shown, the housing 116 may be generally rectangular in cross-section and wherein the magnetic insert 117 therein has a conforming rectangular cross-section.

According to the embodiment shown, magnetic component 106 may be approximately 5 mm² and approximately 1 mm thick.

During manufacture, the magnetic insert 117 may be press fit into the housing 116.

According to the embodiment shown in FIG. 10, to prevent dislodgement of the magnetic insert 117, the magnetic insert 117 may be encased in housing 116 by a lid 134 of biocompatible material, such as titanium. The lid may be welded to the housing, such as using laser welding. In embodiments, the magnetic insert 117 may be coated with a durable biocompatible coating prior to being pressed into the housing 116.

In embodiments, the magnetic insert 117 (or the magnetic component 106) may be hermetically sealed with a biocompatible coating or packaging to seal any permanent magnet or ferromagnetic material from surrounding tissue. This embodiment may be suited for the construction shown in FIG. 1 wherein the magnetic components may adhere directly to a planar spine 105.

With reference to FIG. 2, the implant 100 preferably defines a planar denture facing surface 118 to assist keeping the mucosa 102 relatively flat as is evident from FIG. 7. In this regard, the magnetic insert 117 may define a planar face 119.

The magnetic components 106 may be spaced apart at intervals along the spine 105. The spine 105 may be configured to bend between the magnetic components 106 to conform to patient specific geometry of the palatal process.

In this regard, the implant 101 may be relatively narrower between the magnetic components 106.

The spine 105 may be configured to bend sideways along the length thereof on a plane parallel with an attachment surface plane 120 shown in FIG. 2. As such, the implant 100 may be bend sideways to fit within the available space provided by the palatal process 113 or to avoid the alveolar ridge 113.

Furthermore, the spine 105 may be configured to bend up and down along a length thereof in a plane orthogonal to the attachment surface plane 120.

The spine may be configured to bend both sideways and up and down along the length thereof so as to be able to conform to three-dimensional patient specific geometry of the palatal process 103.

The spine may be less than approximately ¾ the width of the magnetic component 106 between the magnetic components 106. For example, where the magnetic component 106 has a width of 5 mm, the spine 105 may have a width of approximately 4 mm or less.

In embodiments, the implant 101 may provide in-line fixation screw holes 123A along the length of the spine 105 and/or lateral fixation screw holes 123B laterally adjacent the spine 105.

According to this arrangement, the implant 101 may be resiliently attached in alignment with the spine 105 along the length thereof and/or laterally braced.

Furthermore, the lateral fixation screw holes 123B may spread fixation screws apart to avoid likelihood of fracture of the relatively thin palatal process 103. Furthermore, the in-line and lateral fixation holes 123A, 123B allow for choice of fixation screw placement.

Furthermore, each magnetic component 106 may be surrounded by a quadrant of fixation holes 123.

In the embodiment shown in FIG. 3, the spine 105 comprises in-line fixation screw holes 121 between the magnetic components 106. The fixation screw holes 120 may further allow the cutting of the implant 101 to length. FIG. 5 shows an embodiment wherein the spine 105 comprises scoring to assist cutting of the spine 105 between the magnetic components 106.

Furthermore, each side wing may comprise a stem 121 and a distal end 122. The distal end 122 may similarly comprise a fixation screw aperture 123 therethrough.

According to the embodiment shown in FIG. 3, the implant 100 may be resiliently attached using fixation screws along the length of the spine but also at sides of the implant 100.

FIG. 3 also shows wherein the implant 101 comprises end wings 107B which extend beyond the spine 105 and allow for additional in-line fixation screw holes.

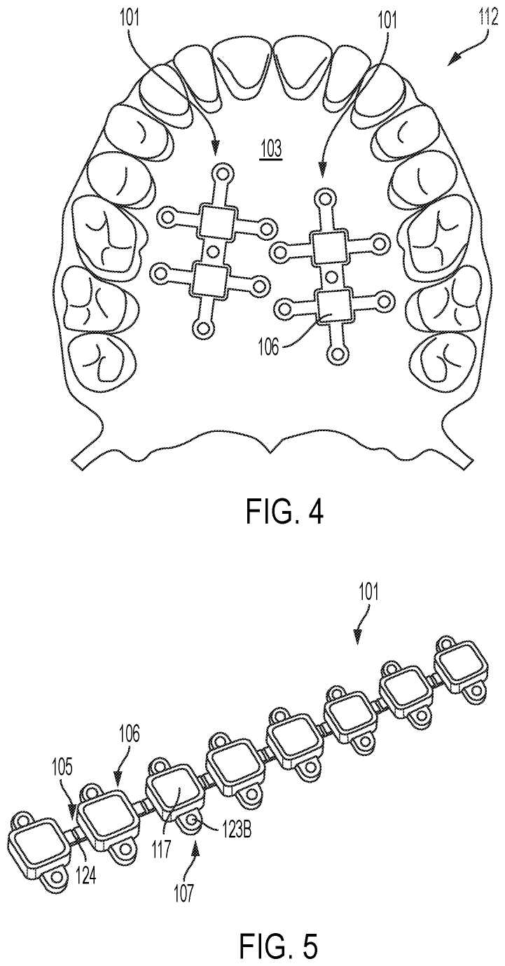

According to FIG. 4, the prosthesis 100 may comprises a pair of palatal implants 101 and wherein the palatal baseplate of the denture has a corresponding pair of denture magnetic components 114 therefor.

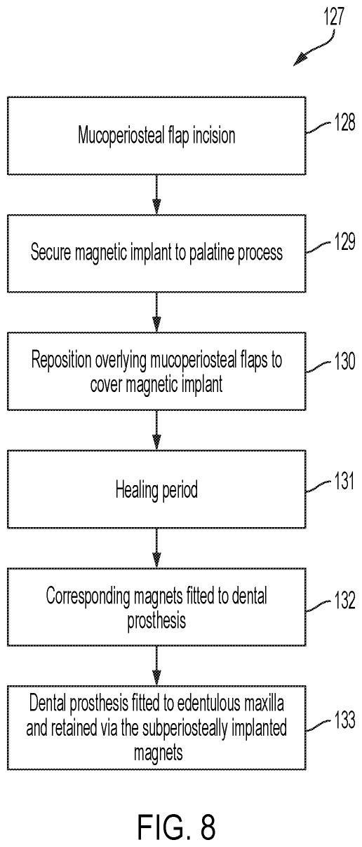

FIG. 8 shows a surgical procedure 127 for the securement of the dental prosthesis 100 by subperiosteal implanting of the implant 101.

The technique 127 may comprise making at least one mucoperiosteal flap incision at step 128. A pair of mucoperiosteal flap incisions may be made for each implant 101.

At step 129, the implant 101 is secured to the underlying bone. With reference to FIG. 4, each strip assembly 101 may be secured to the palatal process 103 using micro screws inserted through respective fixation screw holes 127. Each implant 101 may be bent to lie flat against the palatal process 103 or to avoid the alveolar ridge 113.

At step 130, the mucoperiosteal flaps are repositioned to completely cover the magnetic implant 101 and, at step 131, allowed to heal.

At step 132, corresponding magnetic components (such as comprising magnets of opposite polarity or ferromagnetic pieces) are fitted to existing dental prosthesis. Alternatively, dental prosthesis may be made including the magnetic components at the time of manufacture. The installed position of the implant 101 may be noted during surgery for the corresponding placement of the denture magnetic components 114.

At step 133, the denture 108 is fitted to the edentulous maxilla and retained magnetically by the subperiosteally implanted magnetic components of the implant 101.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A dental prosthesis comprising:
a palatal implant configured to be implanted subperiosteally and attached to a palatal process by a plurality of fixation screws;
a spine provided on the palatal implant;
implant magnetic components provided along the spine, wherein the implant magnetic components define holes therein which are adapted to receive the fixation screws; and
a maxilla denture;
a palatal base plate and an alveolar ridge engaging periphery provided on the maxilla denture;
false teeth installed on the maxilla denture; wherein, the maxilla denture is configured to be placed in a mouth to engage a maxilla, wherein the alveolar ridge engaging periphery of the maxilla denture engages an alveolar ridge of the maxilla;
a plurality of denture magnetic components provided on the maxilla denture;
wherein said plurality of denture magnetic components is configured to align with the implant magnetic components of the palatal implant so that the maxilla denture is magnetically retained in the mouth by magnetic attraction force between the implant magnetic components and the plurality of denture magnetic components.

2. The dental prosthesis as claimed in claim 1, wherein the palatal implant is less than 4 mm thick or the palatal implant is approximately 1 mm thick.

3. (canceled)

4. The dental prosthesis as claimed in claim 1, wherein the maxilla denture is configured to allow a gap between the palatal base plate and oral mucosa covering the palatal process.

5. The dental prosthesis as claimed in claim 1, wherein the palatal implant magnetic components are hermetically sealed;
wherein each palatal implant magnetic component comprises a housing and a respective magnetic insert installed therein;
wherein the magnetic insert defines a planar face; and
wherein a lid is configured to retain the magnetic insert in the housing.

6. (canceled)

7. (canceled)

8. (canceled)

9. The dental prosthesis as claimed in claim 5, wherein the palatal implant magnetic component defines a rear opening through an attachment surface of the palatal implant or palatal implant magnetic component and wherein the magnetic insert is installed rearwardly through a rear opening into the housing.

10. The dental prosthesis as claimed in claim 1, wherein the palatal implant defines a planar surface facing the maxilla denture and the palatal implant magnetic components define planar faces.

11. (canceled)

12. The dental prosthesis as claimed in claim 1, wherein the implant magnetic components are spaced apart at intervals along the spine and the spine is configured to bend between the implant magnetic components.

13. (canceled)

14. The dental prosthesis as claimed in claim 12, wherein the spine is narrower between the implant magnetic components than the implant magnetic components, the spine between the implant magnetic components being less than ¾ of a width of one of the implant magnetic components.

15. (canceled)

16. The dental prosthesis as claimed in claim 14, wherein the spine is configured to bend sideways along a length thereof in a plane parallel with an attachment surface plane or the spine is configured to bend up and down along a ledge thereof in a plane orthogonal to the attachment surface plane or the spine is configured to bend sideways and up and down along a length thereof in a plane parallel with the attachment surface plane.

17. (canceled)

18. (canceled)

19. The dental prosthesis as claimed in claim 1, wherein the palatal implant includes in-line fixation screw holes along a length of the spine, or lateral fixation screw holes laterally adjacent the spine, or in-line fixation screw holes along the length of the spine and lateral fixation screw holes laterally adjacent the spine; and wherein each implant magnetic component is surrounded by a quadrant of fixation screw holes.

20. (canceled)

21. (canceled)

22. (canceled)

23. The dental prosthesis as claimed in claim 19, wherein the in-line fixation screw holes are provided on the spine between the implant magnetic components.

24. The dental prosthesis as claimed in claim 1, wherein the spine is scored between the implant magnetic components.

25. The dental prosthesis as claimed in claim 19, wherein the palatal implant includes side wings defining the lateral fixation screw holes, each side wing comprises a stem and a distal end; wherein the distal end defines a fixation screw aperture therethrough, the distal end being wider than the stem; and wherein each side wing is configured to bend up and down in a plane orthogonal to an attachment surface plane or the implant further comprises end wings which extend in alignment with the spine, and each end wing defines a respective in-line fixture aperture therethrough.

26. (canceled)

27. (canceled)

28. (canceled)

29. (canceled)

30. The dental prosthesis as claimed in claim 1, wherein the palatal implant defines a planar attachment surface or the palatal implant defines opposite planar surfaces.

31. (canceled)

32. The dental prosthesis as claimed in claim 1, wherein the dental prosthesis comprises a pair of palatal implants and wherein the palatal base plate of the maxilla denture has corresponding denture magnetic components for the pair of palatal implants.
